(19) United States
(12) Patent Application Publication
(10) Pub. No.: US 2004/0067748 A1
(43) Pub. Date: Apr. 8, 2004

(54) Method for providing communications equipment

(76) Inventor: Jeffrey A. Johnson, Alpharetta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/264,186

(22) Filed: Oct. 3, 2002

(51) Int. Cl. H04M 11/00; H04M 1/66

(52) U.S. Cl. 455/409; 455/406; 455/410

(57) ABSTRACT

A method of leasing wireless equipment from a leasing entity and distributing the equipment to customers is presented. The method includes receiving a request for a wireless device from a customer, leasing the wireless device from a leasing entity, and providing the wireless device to the customer.

### RELATED APPLICATIONS

This application is related to commonly owned U.S. patent application Ser. No.______, entitled “System for Providing Communications Equipment,” filed on the same date herewith.

### FIELD OF THE INVENTION

The present invention relates to a system and method for distributing wireless communications devices to customers and more particularly to a system and method for leasing wireless devices from an original equipment manufacturer or a third party, and subsequently providing those devices to wireless subscribers.

### BACKGROUND OF THE INVENTION

A wireless communications provider, such as a provider of cellular telephone service, often supplies its subscribers with wireless devices. For example, a customer who desires cellular telephone service or wireless device may obtain this service along with a cellular telephone from a wireless communications provider. Typically, a customer enters a wireless provider's store and requests cellular service in the form of a subscription agreement. The customer, upon signing the subscription agreement, is often supplied with a wireless device, such as a cellular telephone or wireless data device. Typically, at least a portion of the cost of the wireless device is absorbed by the wireless provider while the remainder of the cost of the wireless device is reflected in the subscription agreement. For example, a wireless provider may distribute cellular telephones to its customers at little or no cost when those customers enter into a subscription agreement of some fixed length. In the normal course of business, the wireless provider must acquire sufficient wireless devices to distribute to its customers.

Typically, a wireless provider purchases these wireless devices from an original equipment manufacturer (OEM). A wireless provider purchases large quantities, often in the millions, of cellular telephones from OEMs such as Nokia, Motorola, Ericsson, Samsung, and others. Since each wireless subscriber requires a wireless communications device, wireless providers are often the largest distributor of wireless communication devices to end users. In fact, most new wireless subscribers obtain their wireless communications devices from their wireless providers. As such, a wireless provider must purchase large quantities of wireless devices such as cellular telephones to satisfy its subscriber's needs. Since the purchase of wireless devices by a wireless provider typically runs into the hundreds of millions of dollars annually, the capital outlay for such purchases is often a significant drain on corporate capital.

Most commonly, the purchase of these wireless devices is treated as an expense by a wireless provider. As such, the wireless provider exchanges money, such as cash on hand, to purchase the wireless devices. When expensing the purchase of wireless devices, the wireless provider must pay all of the taxes associated with that purchase at the time the purchase is made. Therefore, the wireless provider must not only come up with the money for the purchase price, but also with the money for the taxes. In purchasing millions of wireless devices annually, this monetary outlay can often run into the hundreds of millions of dollars.

Alternatively, a wireless provider may capitalize the purchase of the wireless devices. In capitalizing the purchase, the wireless provider typically obtains a loan which appears as a liability on the balance sheet and purchases the wireless devices with the proceeds from that loan. The wireless devices then appear as an asset on the balance sheet (at least temporarily). Once again, the purchase of the wireless devices with the loan requires the wireless provider to obtain financing. Since the life cycle of these wireless devices is typically short (12 to 36 months), the loan is commonly amortized over this short period of time. In some cases, the wireless provider may be able to take depreciation on the wireless devices. As is known, the entire cost of an asset may be recovered through depreciation over the depreciable life of that asset. In addition, the wireless provider is responsible for taxes associated with the purchase of the wireless devices. These taxes may be due upon the purchase of the wireless devices.

Therefore, it would be desirable to structure the acquisition of wireless devices so as to free up capital for other uses. The present invention addresses one or more of the above issues.

### SUMMARY OF THE INVENTION

In accordance with the principles of the present invention, a method of distributing a wireless device to a customer includes receiving a request for the wireless device from the customer, leasing the wireless device from a leasing entity, and providing the wireless device to the customer.

In another aspect of the present invention, a method of providing a wireless device to a customer includes receiving a request for the wireless device from the customer, performing a credit check on the customer, initiating a lease for the wireless device from a leasing entity, structuring a contract based on a credit rating of the customer, and providing the wireless device to the customer based on the terms of the contract.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a flow diagram of a method for acquiring and distributing wireless devices consistent with the principles of the present invention.

FIG. 2 is a further method for acquiring and distributing wireless devices consistent with the principles of the present invention.

FIG. 3 is a system for acquiring and distributing wireless devices consistent with the principles of the present invention.

FIG. 4 is a diagram of a computer component of FIG. 3.

FIG. 5 is a block diagram of an automated method of acquiring and distributing wireless devices performed by the system of FIG. 3.

FIG. 6 is a flow diagram depicting the initial step of FIG. 5.

FIG. 7 is a flow diagram depicting the second step of FIG. 5.

FIG. 8 is a flow diagram depicting the third step of FIG. 5.

FIG. 9 is a flow diagram depicting the final step of FIG. 5.

FIG. 10 is a flow diagram depicting an alternate version of the final step of FIG. 5.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

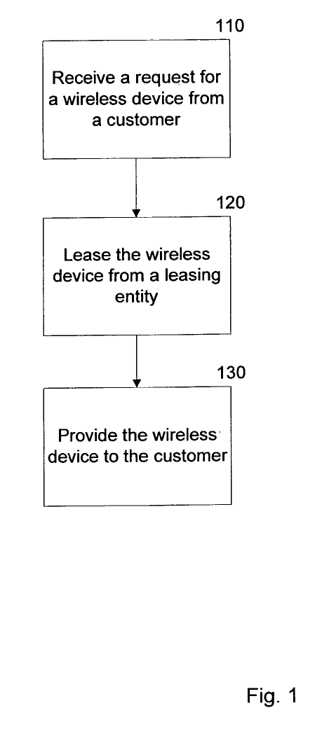

Consistent with the general principles of the present invention, a method for acquiring and distributing wireless devices includes receiving a request for a wireless device from a customer, leasing the wireless device from a leasing entity, and providing the wireless device to the customer. As herein embodied and illustrated in FIG. 1, a method for acquiring and distributing wireless devices is provided.

In exemplary step 110, a request for a wireless device is received from a customer. In this manner, the method of the present invention may be demand driven—that is driven by customer demand. Typically, a customer enters a store operated by a wireless provider to sign up for wireless service. For example, a customer may wish to procure cellular telephone or data service. The customer's request or demand for service drives the acquisition process. In addition to receiving a request from a customer in person, a customer may enter a request through an Internet site, over the telephone, retail or wholesale outlets/stores or through any other convenient means.

After receiving the request for the wireless device from the customer, flow proceeds to step 120 in which the wireless provider leases the wireless device from a leasing entity. At this stage in the process, the wireless subscriber obtains the requested wireless device through a separate leasing entity. For example, the leasing entity, which may be a separate corporation, procures the wireless device from an OEM and then leases that device to the wireless provider. Alternatively, the wireless provider may lease a pool of wireless devices initially and then provide those devices to wireless subscribers at a later time. In this manner, the acquisition of wireless devices via a leasing vehicle may or may not be driven by customer demand.

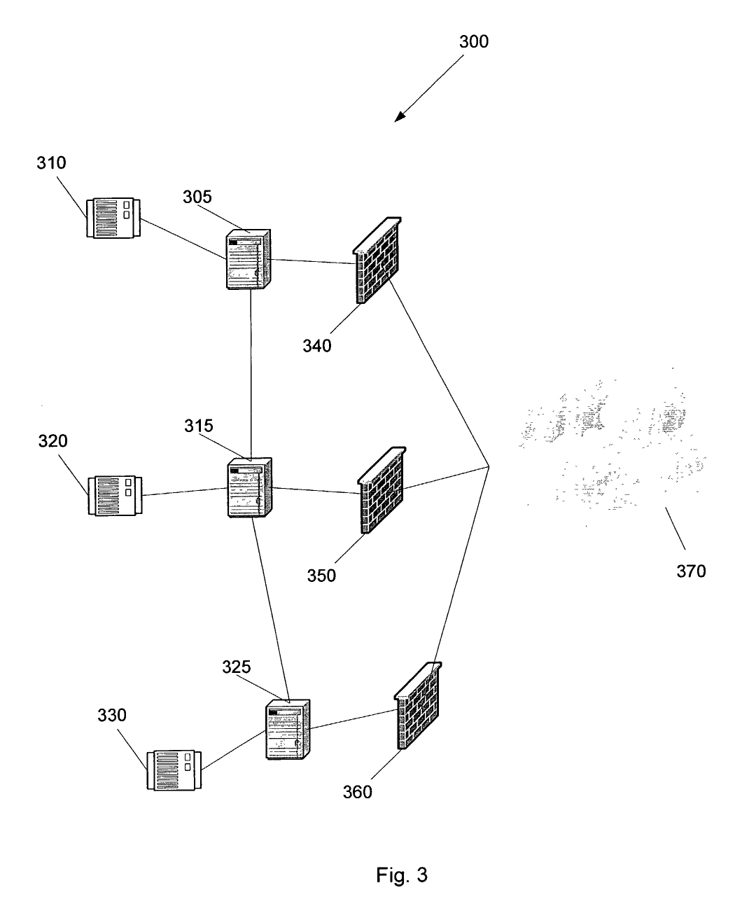

In order to capture many of the benefits of a lease arrangement, the wireless provider leases the wireless devices from a separate leasing entity. This leasing entity, which is typically a corporation, may be a wholly-owned subsidiary of the wireless provider, an affiliated corporation, or a separate leasing company. The wireless provider and the separate leasing entity may share common systems in which to process leases of wireless equipment (as later described with reference to FIG. 3). In this manner, the wireless provider and the separate leasing entity typically have a close working relationship.

The wireless provider and the separate leasing entity may enter into any number of various types of leases. For example, the leasing entity may purchase the wireless devices and simultaneously enter into a capital lease with the wireless provider. Other types of leases, such as operating leases, financial leases, combination leases, sale and lease-back arrangements, or any other convenient type of leasing vehicle may be employed.

For example, the wireless provider may enter into a capital lease with the separate leasing entity. In a capital lease (sometimes referred to as a financial lease), the purchase price of the wireless device is fully amortized. In other words, the lessor receives rental payments equal to the full purchase price of the leased equipment plus a return on invested capital. In a typical arrangement, the wireless provider (the lessee) selects the specific wireless device it requires and negotiates the price with the manufacturer. The separate leasing entity then buys the wireless device from the manufacturer and simultaneously executes a lease contract. The terms of the lease generally call for full amortization of the lessor's investment, plus a rate of return on the un-amortized balance which is close to the percentage rate the lessee would have paid on a secured loan. In this manner, a capital lease is similar to conventional bank loan financing for equipment.

Under a capital lease, the wireless provider makes monthly lease payments that total the purchase price of the wireless device, plus a rate of return. Further, under a typical capital lease, the wireless provider (the lessee) is responsible for any sales tax due on the purchase of the wireless device. This sales tax may be amortized over the length of the lease. Alternatively, this sales tax, in some cases, may be paid in full upon execution of the lease or delayed until the lease expires. Typically, ownership of the wireless device upon termination of a capital lease resides with the lessee.

With a typical capital lease, the residual value of the leased wireless device is zero. In this manner, the full purchase price of the wireless device is amortized over the life of the lease. In other embodiments of the present invention, the residual value may be set to any desired dollar figure. For example, the lease may contain a purchase option, a dollar buy-out option, a percentage buy-out option, various cancellation provisions, and any other required terms.

A capital lease may also be structured in order to take advantage of various tax laws. While a lessee is typically responsible for taxes associated with the purchase of wireless equipment, a tax-oriented lease may be structured so that favorable tax consequences result. The various types of tax-oriented leases are generally known to those skilled in the art.

The use of a capital lease also has an effect on the financial statement of the wireless provider. If the wireless provider is required under the Financial Accounting Standards Board (FASB) standards to capitalize the lease, then the lease is treated much as conventional bank loan financing. For example, FASB Statement 13 requires that for an unqualified audit report, firms that enter into a capital lease must restate their balance sheets to report the lease asset as a fixed asset and the present value of the future lease payments as a liability. Other leasing vehicles, however, are not required to be capitalized.

One such leasing vehicle is an operating lease. In a typical operating lease, the purchase price of the wireless device is not fully amortized. In this manner, only a portion of the purchase price is amortized over the life of the lease. With an operating lease, a residual value exists upon termination of the lease. The dollar amount amortized is the initial purchase price (plus any taxes, if applicable), minus the residual value.

The residual value may be set at any convenient dollar figure. For example, the residual value may be the fair market value of the wireless device at the termination of the lease. Alternatively, the residual value may be set at a dollar figure to allow a purchase option at the end of the lease. Additionally, a dollar buy-out or percentage buy-out may be incorporated into a residual value. In such a case, the lessee is given the option to acquire title to the asset by paying to the lessor the specified amount in the dollar buy-out or percentage buy-out clause. For example, a wireless provider that leases a cellular telephone may enter into an operating lease in which it pays lease installments over a fixed period of time. The wireless provider, at the end of the lease term, may then pay a specified amount of money in order to obtain title to the cellular telephone.

An operating lease typically has beneficial tax effects. If an operating lease qualifies as a genuine lease under Internal Revenue Service guidelines, then the entire lease payment may be fully tax deductible. Generally, for a lease payment to be fully tax deductible, the lease term must not exceed 80% of the estimated useful life of the equipment at the commencement of the lease transaction. Further, the equipment's estimated residual value at the expiration of the lease must equal 20% of its value at the start of the lease, neither the lessee nor any related party can have the right to purchase the lease at a predetermined fixed price at the lease's inception, neither the lessee or any related party can pay or guarantee payment of any part of the price of the leased equipment, and the leased equipment must not be limited use equipment. Generally, operating leases that meet these requirements are given favorable tax treatment. Numerous other tax efficient leases may also be employed and are known to those skilled in the art.

An operating lease may also be used as a form of off balance sheet financing. In such a case, the equipment financed with the operating lease, along with the liability associated with the lease payments, do not appear on a corporation's financial statement. Typically, an operating lease is not required to be capitalized under FASB standards. Therefore, the leased asset is not required to be reported as a fixed asset on the balance sheet. Additionally, the present value of the future lease payments is not required to be reported as a liability on the balance sheet.

For example, suppose that a wireless provider wishes to lease a cellular telephone that costs $200. In addition, suppose that the tax rate is 10% so that the tax on the cellular telephone is $20. If the wireless provider were to purchase the equipment, it would have to expense $220 to acquire the asset. Instead, the wireless provider enters into an operating lease with a separate leasing entity. The useful life of the cellular telephone (also known as its depreciable life) is 24 months. In this case, the wireless provider leases the cellular telephone over a lease term of 18 months. The residual value of the cellular telephone, in this example, is set to the fair market value of $40 at the termination of the lease. The amount to be financed through the operating lease is $200 (the price of the cellular telephone), minus $40 (the fair market value at the end of the lease—18 months). In this case, financing charges, which includes interest, totals $20. Therefore, the total amount of the lease payments over the 18 months is $160, plus $20, or $180. The lease payments are split equally among the 18 months which yields a monthly lease payment of $10. Note that, in this case, the taxes of $20 are deferred until the end of the lease. In other possible embodiments, the taxes may be amortized over the life of the lease. In this example, the lease payments of $10 are fully tax deductible because they meet IRS guidelines. In this manner, $10 per month may be expensed by the wireless provider and treated as a tax deduction. The leasing entity retains title to the wireless device and therefore receives the ownership benefits (depreciation). The wireless provider receives the tax benefits, as well as the beneficial effects to the balance sheet.

As an example of a capital lease, suppose a wireless provider wishes to procure a $100 cellular telephone. Further, assume that the sales tax on the telephone is 10% for a total capital outlay of $110. Conventionally, a wireless provider would expense the entire $110 upon purchase of the telephone. In this case, the total finance charges are $10. Assuming that the telephone has a useful or depreciative life of 10 months, the monthly lease payments are $12. In this case, the entire cost of the telephone, including taxes and finance charges is distributed evenly over the 10 month term of the lease. Alternatively, if taxes are deferred until the termination of the lease, then the monthly lease payment is $11. Since this is a capital lease, the wireless provider may deduct $1 per month in finance charges. In this manner, a capital lease is treated much like bank loan financing. In addition, the wireless provider may be able to deduct sales taxes which total another $1 per month. In this case, the residual value is zero, the wireless provider acquires title to the cellular telephone upon termination of the lease, and the lease itself is capitalized on the wireless provider's balance sheet.

The foregoing are merely two examples of any number of various types of lease a wireless provider and leasing entity may execute. As is known, different types of leases have different tax consequences and different consequences for the balance sheet. A preferred type of lease depends on the facts and circumstances of a particular wireless provider's financial situation.

After leasing the wireless device from a leasing entity, flow then proceeds to Step 130, in which the wireless provider provides the wireless device to the customer. In addition to physically supplying the wireless device to the customer, the wireless provider may assign or transfer its rights in the wireless device to the customer.

For example, the wireless provider may sublease the wireless device to the subscriber. In such a case, the wireless provider may obtain sublease rights from the leasing entity. The terms of the sublease may be incorporated with the terms of the service agreement. Such a sublease may also include a residual value, a dollar buy-out, or zero buy-out. In this manner, the customer, who is a sublessee, pays monthly lease payments for the wireless device. These monthly lease payments may be incorporated into the monthly payments of the service agreement. In this manner, the wireless customer may receive a single bill each month. A portion of the payment reflected in the bill may then go toward the provision of wireless services and a second portion may reflect the sublease payment.

Alternatively, the wireless provider may transfer ownership of the wireless device to the customer upon initiation of the service agreement. In this case, the wireless provider obtains ownership rights to the wireless device in exchange for a promise to make the lease payments to the leasing entity. In other words, ownership is transferred to the wireless subscriber, while the wireless provider remains responsible for the lease payments to the leasing entity. To the wireless customer, this transfer of the wireless device seems just like a sale of the device.

In other embodiments consistent with the present invention, the transfer of any number of ownership or possession rights associated with a wireless device may occur in conjunction with Step 130. For example, the leasing company may retain ownership of the device, while the wireless subscriber retains possession rights to the device. Alternatively, the wireless subscriber may retain both ownership and possession rights to the wireless device. In other embodiments, ownership rights to the device may be transferred to the wireless subscriber at the termination of the lease.

The physical delivery of the device to the customer may occur in any number of different ways. For example, the device may be direct shipped to the customer from the OEM, the device may be provided in a just-in-time delivery system, or the device may be provided from a warehouse.

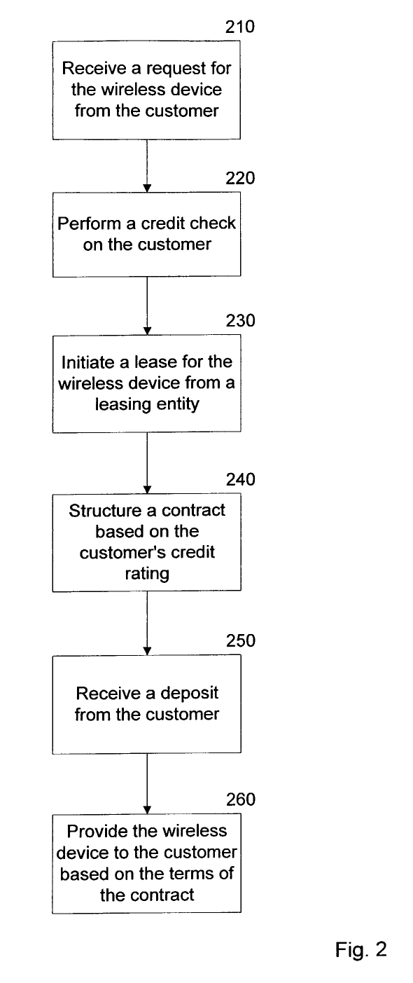

FIG. 2 depicts a flow diagram of a method for acquiring and providing a wireless device to a customer. In this method, a wireless provider receives a request for a wireless device from a customer, performs a credit check on the customer, initiates a lease for the wireless device from a leasing entity, structures a contract based on the customer's credit rating, receives a deposit from the customer, and provides the wireless device to the customer based on the terms of the contract. The method of FIG. 2 is similar to that of FIG. 1.

In exemplary step 210, the wireless provider receives a request for the wireless device from the customer. This step is similar to that previously described with reference to step 110 of FIG. 1.

Flow then proceeds to step 220, in which the wireless provider performs a credit check on the customer. The wireless provider may send the customer's information to any one of a number of commercially available credit agencies. The credit agency may then run the customer's information on its computer and return credit information to the wireless provider. Typically, a customer's credit is checked before that customer is allowed to enter into a service agreement.

After receiving the customer's credit information, flow then proceeds to step 230, in which the wireless provider initiates a lease for the wireless device from a leasing entity. The various leases and lease terms previously described may be implemented in step 230.

In step 240, the wireless provider structures a contract based on the customer's credit rating. Typically, this contract is in the form of a service agreement. Any purchase or sublease of the wireless device may also be incorporated into this contract. The terms of the contract may be influenced by the customer's credit rating. For example, a customer with good credit may receive more favorable contract terms, while a customer with poor credit may receive less favorable contract terms. In addition, the length of the service agreement, as well as the length of the sublease agreement, is incorporated into this contract. A customer with a poor credit rating may be required to enter into a short-term contract with higher monthly payments.

Additionally, a customer with a poor credit rating may be required to submit a deposit upon initiation of the service agreement. As depicted in step 250, the wireless provider receives this deposit from the customer. The deposit may be used to offset some of the risk associated with a customer with a poor credit rating. Alternatively, the deposit may function as an up-front present value payment for some of the lease payments associated with the wireless device. In other situations, the deposit may offset some of the initial cost of the wireless device. The presence of the deposit, as well as the amount of the deposit may be tied to the customer's credit rating.

Upon receiving a deposit, flow then proceeds to step 260, in which the wireless provider provides the wireless device to the customer based on the terms of the contract. As mentioned in relation to step 130 of FIG. 1, the wireless provider may transfer either ownership or possession rights or both to the customer.

FIG. 3 is a system for acquiring and providing wireless devices. In the exemplary system 300 of FIG. 3, a number of computers and databases are interconnected in a network arrangement. In addition, the computers are interfaced with one another via the Internet.

The exemplary system 300 of FIG. 3 comprises a retail store computer 305, a retail store database 310, a wireless provider computer 315, a wireless provider database 320, a leasing entity computer 325, a leasing entity database 330, firewalls 340, 350, and 360, and the Internet 370. In this embodiment, retail store computer 305 is connected to retail store database 310, wireless computer provider 315, and firewall 340. Further, retail store computer 305 may interface with wireless provider computer 315 and leasing entity computer 325 via the Internet. Wireless provider computer 315 is connected to wireless provider database 320, retail store computer 305, leasing entity computer 325, and firewall 350. In addition, wireless provider computer 315 may interface with retail store computer 305 and leasing entity computer 325 through the Internet 370. Leasing entity computer 325 is connected to leasing entity database 330, wireless provider computer 315, and firewall 360. Leasing entity computer 325 may interface with wireless provider computer 315 and retail store computer 305 via the Internet 370.

In other embodiments of the present invention, the interface between retail store computer 305, wireless provider computer 315, and leasing entity computer 325 may be through any convenient means. For example, the interface between these three computers may occur over a private leased line, a network connection, or any other convenient communication connection. In other embodiments of the present invention, the interface may occur solely through the Internet 370. If security is an issue, then the interface between these three computers, 305, 315, and 325, may occur over a secured communications medium. For example, the three computers, 305, 315, and 325, may communicate via the Internet using a secured hypertext transport protocol. Alternatively, these three computers may communicate with one another over a private network.

In the exemplary embodiment of FIG. 3, firewalls 340, 350, and 360 are interposed between computers 305, 315, and 325 and the Internet 370. As is known in the art, firewalls 340, 350, and 360 serve to isolate the computers from the Internet 370. Since these three computers handle various transactions, firewalls 340, 350, and 360 serve to protect the information processed by these three computers. Alternatively, any other number of security features commercially available and known to those skilled in the art may be employed with the system 300 of FIG. 3.

Databases 310, 320, and 330 may be implemented with commercially available software and equipment and may each contain information about a customer, the customer's transactions, and the customer's desired wireless device. For example, retail store database 310 may contain customer information, including the customer's service agreement, the customer's preferred wireless device, the customer's order information, and the customer's payment information. Retail store database 310 may also contain various order fulfillment information, inventory information, and any other information necessary for the retail store to conduct business with the general public.

Wireless provider database 320 may contain a duplicate of the information contained in retail store database 310. Wireless provider database 320, in this example, is a master database contained within a wireless provider's infrastructure. In addition to customer information, wireless provider database 320 may also contain information about leases to which the wireless provider and the leasing entity are a party. Further, wireless provider database 320 may also contain information about the transfer of ownership and possession rights of a wireless device to a particular customer. For example, wireless provider database 320 may contain sublease information or sale information for a transaction with a particular wireless subscriber. In this manner, wireless provider database 320 may contain various forms of transaction information between a customer and a wireless provider, as well as a wireless provider and a leasing entity. Wireless provider database 320 may further contain inventory information, shipping information, and payment information associated with a particular wireless subscriber.

Leasing entity database 330 typically contains information about the transactions into which the wireless provider and the leasing entity enter. For example, leasing entity database 330 may contain information about the number and types of leases that the wireless provider and the leasing entity execute. Leasing entity database 330 may further contain an inventory of the leased wireless devices, payment schedules, financing terms, and any other information necessary for the leasing process.

While the system 300 of FIG. 3 is depicted with three computers and three databases, any number of computers and databases may be interfaced into a system of acquiring wireless devices and providing them to customers. Further, not all of the listed databases are necessary for proper operation of the system. For example, retail store database 310 may be housed within wireless provider database 320. In this embodiment, a single database 320 resides within the wireless provider's network. This single database 320 may then receive all information from various retail store computers, such as retail store computer 305.

In this central database configuration, each of the various retail store computers, such as retail store computer 305, may interface directly with wireless provider database 320. The system 300 of FIG. 3 may operate on an electronic data interface protocol, an XML protocol, an E-commerce protocol, or any other convenient communications protocol.

Retail store computer 305, wireless provider computer 315, and leasing entity computer 325 may be any type of computing device. In the exemplary embodiment 300 of FIG. 3, these three computers are servers. In a typical installation, retail store computer 305 may comprise a personal computer with various communications interfaces. Wireless provider computer 315 may be a single computing device or multiple computing devices. Wireless provider computer 315 may be a minicomputer, server, personal computer or any other convenient type of computing device. Likewise, leasing entity computer 325 may also be a computer configured to send and receive transaction data.

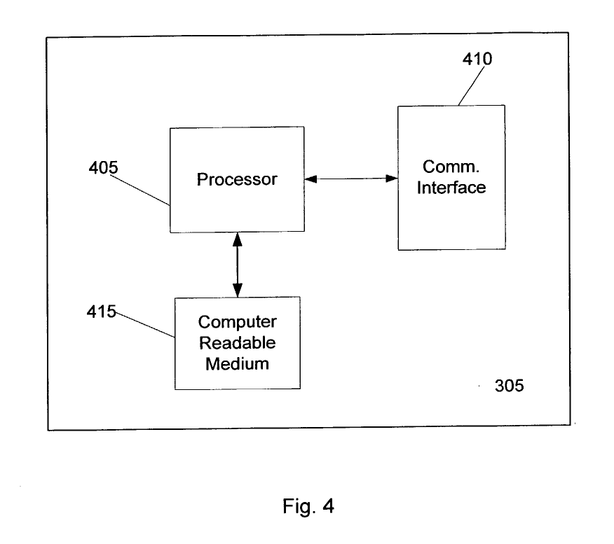

FIG. 4 is a block diagram of retail store computer 305 of FIG. 3. In addition, the block diagram of FIG. 4 may also represent wireless provider computer 315 and leasing entity computer 325. In the exemplary embodiment of FIG. 4, retail store computer 305 comprises processor 405, communications interface 410, and computer readable medium 415. Processor 405 is connected to communications interface 410 and computer readable medium 415.

Processor 405 may be any type of computer processor, such as a microprocessor. Communications interface 410, likewise, may be any type of communications interface, such as an Ethernet or LAN card. Computer readable medium 415 is typically a magnetic or optical storage device, but may be any convenient type of storage medium

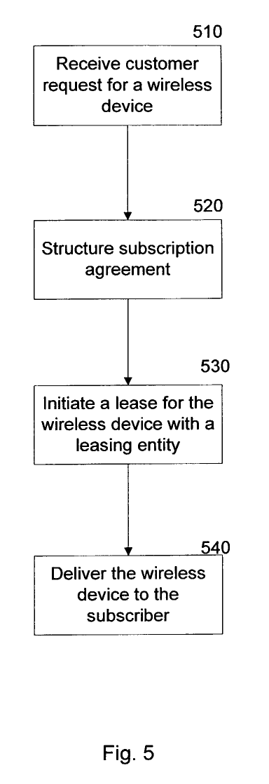

FIG. 5 is a flow diagram depicting one example of the operation of system 300 of FIG. 3. In this exemplary embodiment, system 300 operates to receive customer requests for wireless devices, structure subscription agreements, initiate leases for the wireless devices with a leasing entity, and deliver the wireless devices to the subscribers.

In exemplary step 510, retail store computer 305 receives a customer request for a wireless device. Typically, a salesperson at the retail store enters customer information into retail store computer 305. Alternatively, the customer, via the Internet, may request a wireless device. In such a case, the customer may communicate either with retail store computer 305 or wireless provider computer 315. In a further embodiment, a customer may request a wireless device from a wireless provider via the telephone. The customer request, along with customer information is then received by retail store computer 305 or wireless provider computer 315.

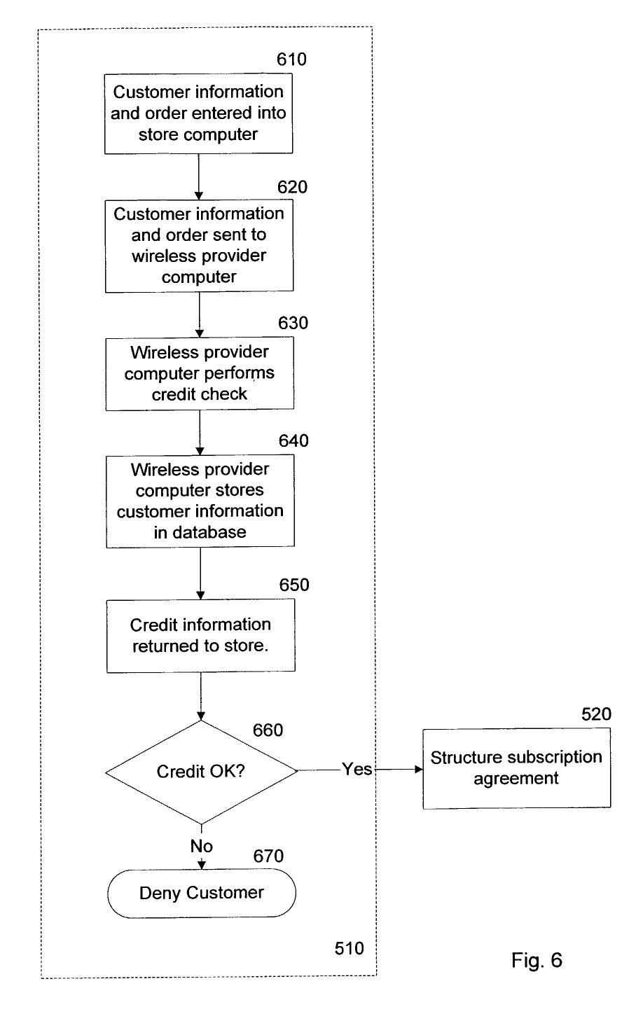

FIG. 6 is a flow diagram depicting various exemplary steps contained within step 510 of FIG. 5. Each of the steps of FIG. 6 serve to further clarify the receipt of a customer request for a wireless device.

Flow beings in step 610 in which a customer's information and order are entered into the retail store computer 305. As mentioned, this information and order may be entered into retail store computer 305 by personnel at the retail store or over the Internet by the customer himself. Flow then proceeds to step 620 in which the customer information and order are sent to wireless provider computer 315. This information and order may be sent via the Internet 370 or via a private communications connection. In step 630, the wireless provider computer performs a credit check on the customer. As previously noted, wireless provider computer 315 may interface with any number of readily available credit agency computers to obtain credit information on the customer.

In step 640, wireless provider computer 315 stores the customer information in wireless provider database 320. For example, wireless provider computer 315 may create a new record on wireless provider database 320 in which to store the customer's information and order. In step 650, wireless provider computer 315 returns the customer's credit information to store computer 305. In one embodiment, wireless provider computer 315 may simply forward credit information from a credit agency computer to store computer 305.

In step 660, wireless provider computer 315 or retail store computer 305 determines if the customer's credit rating is sufficient for the wireless provider to do business with the customer. This decision step may be performed by wireless provider computer 315 in which case a simple approval or denial may be sent from wireless provider computer 315 to retail store computer 305. In such a case, wireless provider computer 315 may interface with a credit agency computer. If the customer's credit rating is insufficient, then flow proceeds to step 670 in which the customer is denied a subscription agreement and wireless device. If a customer's credit rating is sufficient, the flow proceeds to step 520 of FIG. 5 in which the wireless provider computer 315 or retail store computer 305 structures a subscription agreement for the customer.

In exemplary step 520 of FIG. 5, a subscription agreement is structured based on a number of different factors. For example, wireless provider computer 315 may have an array of variables that it evaluates in structuring a subscription agreement. Typically, these variables include the customer's credit rating, the type of service a customer desires, the wireless device a customer desires, and various other factors. Wireless provider computer 315 may comprise a computer readable medium on which decision software resides. This decision software may be configured to automatically structure a subscription agreement, wireless device sublease, wireless device sales agreement, or any other agreement between a wireless provider and a customer. This automated system may be capable of tailoring an agreement that meets the needs of the wireless provider and the customer.

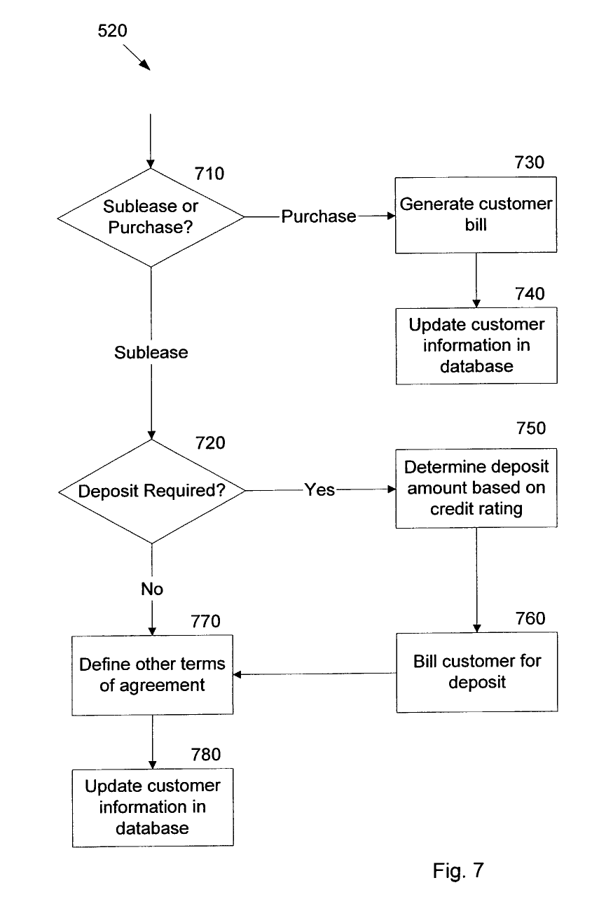

An example of this decision software is depicted in FIG. 7. FIG. 7 depicts exemplary steps which may comprise step 520 of FIG. 5. Flow begins in step 710 in which wireless provider computer 315 determines whether a customer wishes to sublease or purchase a wireless device. If a customer wishes to purchase a wireless device, then flow proceeds to step 730 in which the wireless provider computer 315 or the retail store computer 305 generates a customer bill. Flow then proceeds to step 740 in which the customer information is updated in the database. For example, a customer wishing to purchase a cellular telephone may receive a bill for that telephone or pay for the telephone at the retail store. Wireless provider computer 315 may then update wireless provider database 320 with the customer's payment information and billing information.

If in step 710 the customer subleases the wireless device from the wireless provider, then flow proceeds to step 720 in which the wireless provider computer 315 determines whether or not a deposit is required. As mentioned, a deposit may be based on a customer's credit rating. If a deposit is required, then flow proceeds to step 750 in which the wireless provider computer 315 determines the deposit amount based on the customer's credit rating. Flow then proceeds to step 760 in which a bill is produced for the deposit. Flow then proceeds to step 770 in which wireless provider computer 315 defines other terms of the agreement.

If a deposit is not required in step 720, then flow proceeds directly to step 770 in which wireless provider computer 315 defines other terms of the agreement. Flow then proceeds to step 780 in which wireless provider computer 315 updates the customer's information in wireless provider database 320. In this example, either wireless provider computer 315 or retail store computer 305 may perform the functions depicted in FIG. 7.

After the customer's information is updated in a database in step 780, flow proceeds to step 530 of FIG. 5 in which wireless provider computer 315 initiates a lease for the wireless device with a leasing entity. In exemplary step 530, wireless provider computer 315 interfaces with leasing entity computer 325. Customer information and product information is exchanged between wireless provider computer 315 and leasing entity computer 325. Since this is an automated process, wireless provider computer 315 transfers device information, a desired lease term, and any other pertinent information to leasing entity computer 325. Typically, leasing entity computer 325 performs the various calculations needed to determine a lease payment. In addition, leasing entity computer 325 may set various terms of the lease or may simply refer to a master lease agreement between the wireless provider and the leasing entity. Leasing entity computer 325 then typically sends lease information back to wireless provider computer 315.

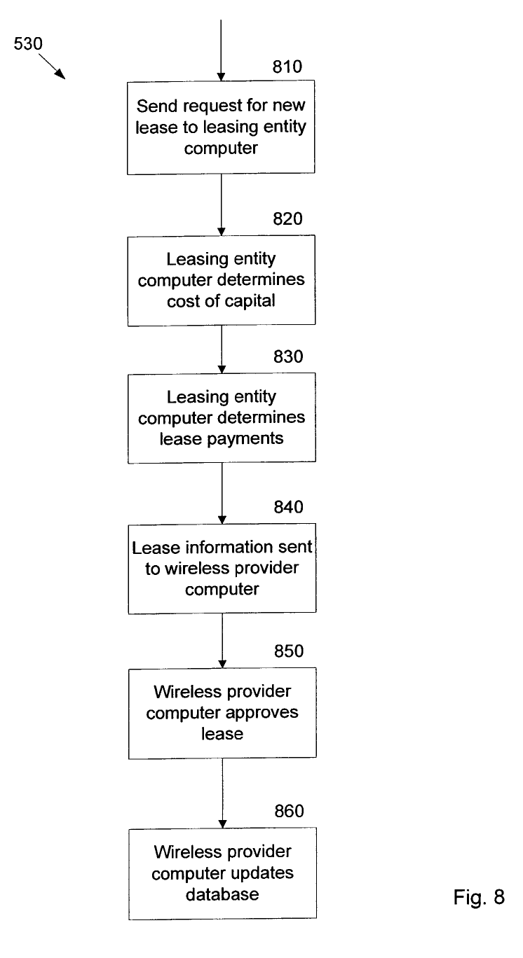

The interaction between wireless provider computer 315 and leasing entity computer 325 is described more fully in FIG. 8. FIG. 8 is a flow diagram of the exemplary steps which may occur in executing step 530 of FIG. 5.

In step 810 of FIG. 8, wireless provider computer 315 sends a request for a new lease to leasing entity computer 325. Wireless provider computer 315 may provide information such as the type of wireless device to leasing entity computer 325. Leasing entity computer 325 may then use this type of device as a starting point for structuring a lease agreement between the wireless provider and the leasing entity. In addition, wireless provider computer 315 may send other customer information to leasing entity computer 325.

Flow then proceeds to step 820 in which the leasing entity computer 325 determines the cost of capital. Typically, leasing entity computer 325 fixes the cost of capital at a pre-negotiated interest rate. For example, the wireless provider and the leasing entity, through a master agreement, may set an interest rate at a fixed percentage over the LIBOR rate. As such, this cost of capital may vary slightly from day to day.

Flow then proceeds to step 830 in which leasing entity computer 325 determines the lease payments. At this point, leasing entity computer 325 has received from wireless provider computer 315 information necessary to calculate the lease payments. Based on the type of wireless device leased and the interest rate, leasing entity computer 325, through a simple amortization calculation, can determine the lease payments. For example, leasing entity computer 325 may access the price of a wireless device, a residual value, a lease term, and a cost of capital to determine lease payments.

In one exemplary embodiment, leasing entity computer 325 has access to an OEM computer (not shown). Information may be exchanged between leasing entity computer 325 and the OEM computer (not shown) so that a price for a wireless device can be ascertained. Typically, the leasing entity will have negotiated fixed prices for wireless equipment from various OEMs. These prices along with pre-arranged residual values and tax rates may be used to determine the amount to be amortized into lease payments. In addition, leasing entity computer 325 may place an order for the wireless device with OEM computer (not shown).

After leasing entity computer 325 arranges the various terms and payments of the lease, flow proceeds to step 840 in which the lease and payment information is sent to wireless provider computer 315. After receiving this lease and payment information, wireless provider computer 315 approves the lease as depicted in step 850. In other embodiments of the present invention, wireless provider computer 315 may simply store the lease information in wireless provider database 320. If the lease terms are based on a master agreement, then subsequent leases may be automatically approved by leasing entity computer 325 and accepted by wireless provider computer 315.

Flow then proceeds to step 860 in which the wireless provider computer 315 updates the wireless provider database 320. In addition, leasing entity computer 325 may update its database 330 with the information received from wireless provider computer 315 and the information based on its lease payment calculations.

Flow then proceeds to step 540 of FIG. 5 in which the wireless provider delivers the wireless device to the subscriber. In this step, retail store computer 305, wireless provider computer 315, and an OEM computer (not shown) may be involved. Various information such as the type of wireless device, whether the wireless device is in stock, and shipment information may be exchanged between the various computers.

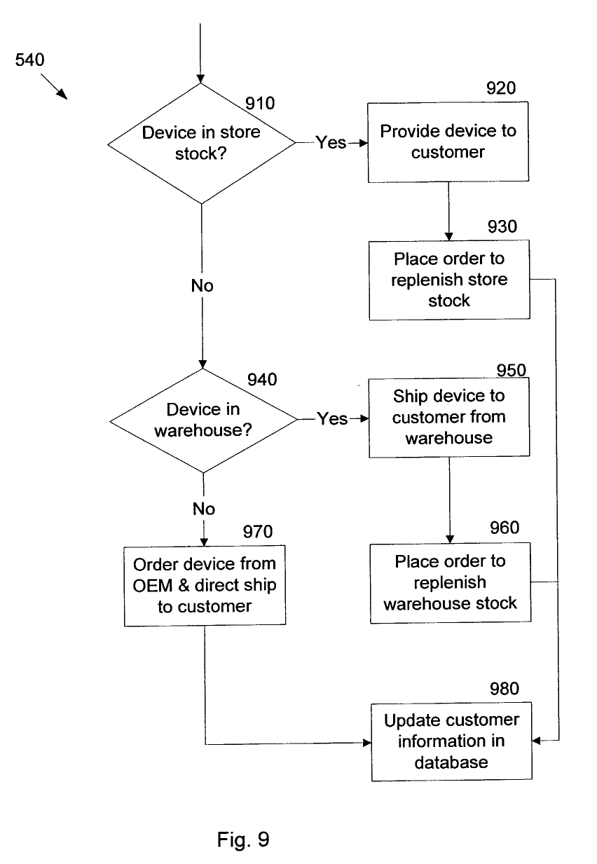

FIG. 9 depicts one exemplary embodiment of step 540 of FIG. 5. In FIG. 9, flow begins in step 910 in which retail store computer 305 determines whether the requested wireless device is in the retail store stock. If the requested wireless device is in the retail store stock, then flow proceeds to step 920 in which the wireless device is provided to the customer. In step 930, retail store computer 305 places an order to replenish store stock. In this exemplary step, retail store computer 305 may communicate with wireless provider computer 315 to request replenishing stock. Alternatively, retail store computer 305 may communicate directly with OEM computer (not shown) to order replacement stock. Flow then proceeds to step 980 in which customer information is updated in retail store database 310 by retail store computer 305. Alternatively, wireless provider computer 315 updates wireless provider database 320 with information about the fulfillment about this customer's order from retail store stock. In an alternate embodiment, wireless provider computer 315 communicates restocking requests to an OEM computer (not shown). In a further embodiment of the present invention, wireless provider computer 315 communicates this restocking request to leasing entity computer 325. In such a case, leasing entity computer 325 may communicate with an OEM computer (not shown) to order the requested wireless device. In this manner, retail store computer 305 may receive stocking information through numerous intermediary computers such as wireless provider computer 315 and leasing entity computer 325. In this embodiment, retail store computer 305 may place an order for replacement stock which is then transmitted via wireless provider computer 315 and leasing entity computer 325 to an OEM computer (not shown). A new lease may then be executed for the replenishing stock, and the replenishing stock may be delivered to the retail store.

If the requested wireless device is not in store stock, then flow proceeds to step 940 in which the retail store computer 305 ascertains whether the requested wireless device is in a warehouse. If the requested wireless device is in a warehouse, then flow proceeds to step 950 in which the retail store computer 305 requests that the wireless device be shipped to the customer from the warehouse. In this manner, retail store computer 305 may communicate with a warehouse computer (not shown) or with wireless provider computer 315. If retail store computer 305 communicates with wireless provider computer 315 regarding warehouse shipments, then wireless provider computer 315 may communicate with a warehouse computer (not shown).

Flow then proceeds to step 960 in which an order is placed to replenish the warehouse stock. As in the case in which an order is placed to replenish store stock, retail store computer 305 may communicate with any number of various computers, such as wireless provider computer 315, leasing entity computer 325, warehouse computer (not shown), or OEM computer (not shown) to initiate an order to replenish the warehouse stock. Flow then proceeds to step 980 in which customer information is updated in a database. For example, wireless provider computer 315 may update wireless provider database 320 and retail store computer 305 may update retail store database 310.

If in step 940, retail store computer 305 determines that the wireless device is not in the warehouse, then flow proceeds to step 970 in which the device is ordered from an OEM and direct shipped to a customer. In exemplary step 970, retail store computer 305 may request a direct shipment from an OEM to a customer by communicating with wireless provider computer 315 or directly with OEM computer (not shown). As in the previous two cases, retail store computer 305 may communicate various wireless device information and customer information either directly to OEM computer (not shown) or through a series of intermediate computers, such as wireless provider computer 315 and leasing entity computer 325, to OEM computer (not shown).

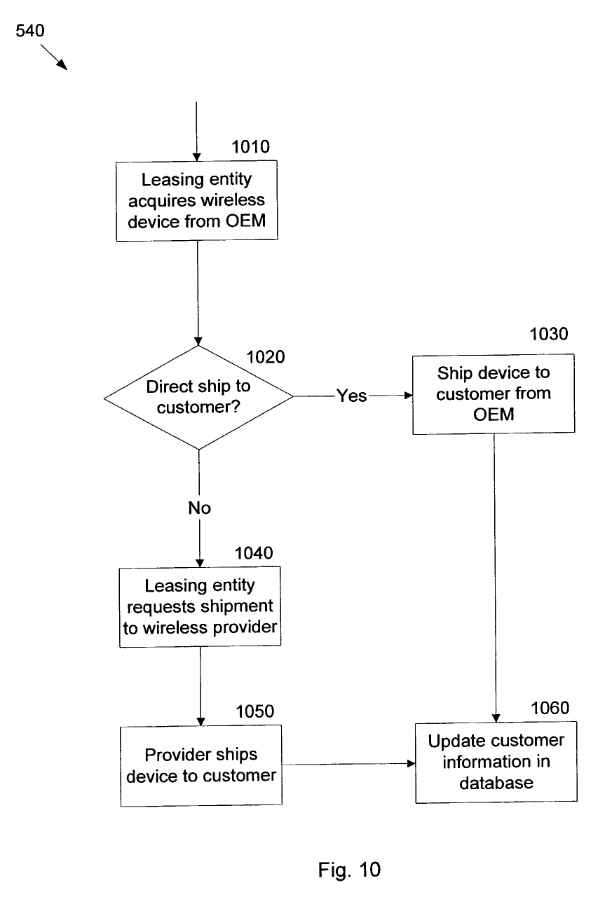

Various other information flows and delivery techniques are also within the scope of the present invention. For example, FIG. 10 depicts a second exemplary embodiment of step 540 of FIG. 5. In FIG. 10, flow begins at step 1010 in which the leasing entity acquires the wireless device from an OEM. In this case, retail store computer 305 has received a request for a wireless device from a customer. This request may then be transmitted from retail store computer 305 to leasing entity computer 325 via wireless provider computer 315. Leasing entity computer 325 may then interface with an OEM computer (not shown) to procure the requested wireless device. In this manner, the acquisition of a wireless device is driven by customer demand. When a customer enters a retail store and orders a new wireless device, the exemplary steps of FIG. 10 are set into motion to acquire that wireless device for the customer.

After the leasing entity computer 325 communicates with the OEM computer (not shown), flow proceeds to step 1020 in which the leasing entity computer 325 determines whether the wireless device is to be shipped directly to the customer. Alternatively, wireless provider computer 315 or retail store computer 305 may make this determination. If the wireless device is to be direct-shipped to a customer, then flow proceeds to step 1030 in which the leasing entity computer 325, for example, sends the necessary information to the OEM computer (not shown) so that the OEM may ship the requested wireless device directly to the customer. Flow then proceeds to step 1060 in which the customer information is updated in a database. In this step, retail store computer 305 may update retail store database 310; wireless provider computer 315 may update wireless provider database 320; and leasing entity computer 325 may update leasing entity database 330.

If in step 1020 the wireless device is not to be shipped directly to the customer, then flow proceeds to step 1040 in which the leasing entity requests that the wireless device be shipped from the OEM to the wireless provider's retail store. In this case, leasing entity computer 325 transmits to OEM computer (not shown) information sufficient to ship the requested wireless device to the wireless provider's retail store. In this manner, a customer may return to the retail store to pick up his requested wireless device. Alternatively, the OEM may ship the wireless device to the wireless provider so that it can be configured for use on the wireless provider's network. Flow then proceeds to step 1050 in which the wireless provider ships the device to the customer and to step 1060 in which customer information is updated in the applicable database.

In the exemplary embodiment of FIG. 10, customer demand drives the acquisition and delivery of wireless devices. The various computers, such as retail store computer 305, wireless provider computer 315, leasing entity computer 325, OEM computer (not shown), and warehouse computer (not shown), may be involved in this demand-driven delivery of wireless devices. As previously noted, the communication among these computers may occur via the Internet 370.

Each of the previous decision steps encompassed by FIGS. 5 through 10 may be performed by any number of computers. These decision steps may be embodied in software stored on computer readable medium accessible by these computers. In such a case, a computer system that automates the leasing and delivery processes may be implemented. Since the lease terms between the wireless provider and the leasing entity are typically standard, the provision of these leases may be automated with wireless provider computer 315 and leasing entity computer 325. In addition, since the various wireless subscription agreements can be premised upon a customer's credit rating, retail store computer 305 and wireless provider computer 315 may comprise an interactive and adaptable system to structure agreements between a wireless provider and a customer. Further, wireless provider computer 315 and retail store computer 305 may also be adapted as a system to define both the delivery of wireless devices to a customer and the replenishment of depleted stock. In such a manner, retail store computer 305, wireless provider computer 315, and leasing entity computer 325 may form a seamless infrastructure that supports both the acquisition of wireless devices and the delivery of those wireless devices to customers. In addition, this system of three computers may be configured to handle the details associated with the transactions that occur in the acquisition and delivery process.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of distributing a wireless device to a customer, the method comprising:
receiving a request for the wireless device from the customer;
leasing the wireless device from a leasing entity; and
providing the wireless device to the customer.

2. The method of claim 1 further comprising:
storing customer information in a database.

3. The method of claim 1 further comprising:
billing the customer for the wireless device.

4. The method of claim 1 further comprising:
performing a credit check on the customer.

5. The method of claim 4 further comprising structuring a lease based on a credit history of the customer.

6. The method of claim 1 further comprising:
receiving a deposit from the customer.

7. The method of claim 6 further comprising:
determining an amount of the deposit based on a credit history of the customer.

8. The method of claim 4 wherein performing a credit check on the customer further comprises receiving credit information from a credit agency.

9. The method of claim 1 wherein the wireless device is selected from one of a cellular telephone, personal digital assistant, pager, wireless browser, or wireless email device.

10. The method of claim 1 wherein leasing the wireless device from a leasing entity is driven by customer demand.

11. The method of claim 1 wherein leasing the wireless device from a leasing entity further comprises entering into a capital lease with the leasing entity.

12. The method of claim 1 wherein leasing the wireless device from a leasing entity further comprises entering into an operating lease with the leasing entity.

13. The method of claim 1 wherein leasing the wireless device from a leasing entity further comprises setting a residual value.

14. The method of claim 13 wherein an amortized dollar amount is a purchase price minus the residual value.

15. The method of claim 13 wherein the residual value is a fair market value.

16. The method of claim 1 wherein leasing the wireless device from a leasing entity further comprises entering into a contract with a purchase option, dollar buy-out option, percentage buy-out option, or cancellation clause.

17. The method of claim 1 wherein providing the wireless device to the customer further comprises selling the wireless device to the customer.

18. The method of claim 1 wherein providing the wireless device to the customer further comprises subleasing the wireless device to the customer.

19. The method of claim 18 wherein a length of a sublease is less than or equal to a length of a wireless subscription.

20. The method of claim 18 wherein a term of a sublease is based on a credit rating of the customer.

21. The method of claim 1 wherein providing the wireless device to the customer further comprises ordering the wireless device from a manufacturer.

22. The method of claim 1 wherein providing the wireless device to the customer further comprises ordering the wireless device from the leasing entity.

23. The method of claim 1 wherein providing the wireless device to the customer further comprises transferring ownership of the wireless device to the customer.

24. A method of providing a wireless device to a customer, the method comprising:
receiving a request for the wireless device from the customer;
performing a credit check on the customer;
initiating a lease for the wireless device from a leasing entity;
structuring a contract with the customer based on a credit rating of the customer; and
providing the wireless device to the customer based on the terms of the contract.
